(19) United States
(12) Patent Application Publication
(10) Pub. No.: US 2026/0230740 A1
(43) Pub. Date: Aug. 6, 2026

(54) HEARING INSTRUMENT COMPRISING AN ELECTRIC CHARGING CIRCUIT

(71) Applicant: WidexA/S, Lynge (DK)

(72) Inventor: Niels Ole KNUDSEN, Humlebaek (DE)

(73) Assignee: WidexA/S, Lynge (DK)

(21) Appl. No.: 19/153,031

(22) PCT Filed: Jan. 8, 2024
(86) PCT No.: PCT/EP2024/050281

§ 371 Date: Aug. 1, 2025

(30) Foreign Application Priority Data
Feb. 2, 2023 (DK) PA202300098

(51) Int. Cl. H04R 1/1025; H02J 7/90; H02J 50/12; H04R 25/00

(52) U.S. Cl. CPC H04R 1/1025; H02J 7/933; H02J 50/12; H04R 25/554; H04R 25/556; H02J 2207/40; H04R 2225/31

(57) ABSTRACT

A hearing instrument having a rechargeable battery, and an electric charging circuit configured to provide an electric charging voltage for charging the battery is provided. The electric charging circuit is equipped to support two charging modes, having a galvanic charging mode in which the electric charging circuit is supplied with an electric voltage by an external voltage source via a galvanic connection to the hearing instrument, and a wireless charging mode in which the electric charging circuit is supplied with an electric voltage by a wireless electric energy receiver.

The invention relates to a hearing instrument comprising a rechargeable battery, and an electric charging circuit configured to provide an electric voltage for charging the battery.

The term “hearing instrument” as used herein relates to a wearable electronic device being designed to support the hearing of a person wearing it (which person is called the user or wearer of the hearing instrument). In particular, the invention relates to a hearing aid, i.e., a hearing instrument that is specifically configured to at least partially compensate a hearing impairment of a hearing-impaired user. Other types of hearing instruments, often denoted as Personal Sound Amplification Products (PSAP), are designed to support the hearing of normal hearing users, i.e., to improve speech perception in complex acoustic situations. The term “hearing instrument” also includes a headset, headphone, ear bud, in-ear radio, etc.

A hearing instrument typically includes a transducer (also referred to as the “output transducer”) being designed to convert an audio signal (i.e. an electric signal transporting a sound information) to a signal that can be perceived as sound by the user. In addition to the output transducer, many hearing instruments (in particular hearing aids, PSAP, headsets and noise-cancelling headphones and ear buds) also include at least one acousto-electric transducer (also referred to as the “input transducer”) being designed to capture a sound from the environment and to convert this sound to an (input) audio signal. The input audio signal may be sent to a remote device for enabling remote communication (e.g. in a phone call) or for being recorded. Additionally or alternatively, the input audio signal may be processed to be output to the user (e.g. to render environment sound hearable or better perceivable to the user or to suppress environment sound for noise-cancelling).

Most often, a hearing instrument is designed to be worn in or at the ear of the user, e.g., as a Behind-The-Ear (BTE) or In-The-Ear (ITE) instrument. With respect to its internal structure, a hearing instrument often comprises a signal processor in addition to the output and input transducers mentioned above. During operation of the hearing instrument, typically the at least one input transducer captures air-borne sound from an environment of the hearing instrument and converts it to the input audio signal. In the signal processor, the input audio signal (transporting the information on the captured sound) is processed, e.g. amplified dependent on sound frequency to support the hearing of the user, in particular to compensate a hearing-impairment of the user. The signal processor outputs a processed audio signal (carrying the information of the processed sound) to the output transducer. Most often, the output transducer is an electro-acoustic transducer (also called the “receiver”) that converts the processed audio signal to a processed air-borne sound, which is emitted into the ear canal of the user. Alternatively, the output transducer may be an electro-mechanical transducer that converts the processed audio signal to a structure-borne sound (vibrations) that is transmitted, e.g., to the cranial bone of the user. Furthermore, besides classical hearing instruments as described before, there are implanted hearing instruments such as cochlear implants, and hearing instruments the output transducers of which output the processed sound by directly stimulating the auditory nerve of the user.

The term “hearing system” as used herein denotes an assembly of devices and/or other structures providing functions for the operation of a hearing instrument. A hearing system may comprise a hearing instrument and at least one further electronic device, which may be, e.g., one of another hearing instrument for the other ear of the user, a remote control, a programming tool and an external microphone for the hearing instrument. Moreover, modern hearing systems often comprise a software application (app) for controlling and/or programming the hearing instrument, which software application is or can be installed on a computer or a mobile communication device such as a mobile phone (smartphone). In the latter case, typically, the computer or the mobile communication device is not a part of the hearing system but is only used by the app as a resource for computing power, memory and communication services. Most often, the computer or the mobile communication device will be manufactured and sold independently of the hearing system.

Modern hearing instruments are often powered by rechargeable batteries that cannot be removed for charging. Instead, hearing instruments of this kind are typically charged by connecting the hearing instrument with a suited charging device (subsequently referred to as the “charger”). The electric connection between the hearing instrument and the charger may be either galvanic or wireless. In the prior case, the charger provides energy to the hearing instrument by exchanging electric charge carriers (electrons) with the hearing instrument. In the latter case energy is provided to the hearing instrument by via electric, magnetic or electro-magnetic fields emitted by the charger.

In order to provide an electric (charging) voltage to charge the battery, a hearing instrument typically comprises an electric charging circuit. In conventional hearing instruments, different electric charging circuits have been used for galvanic charging and wireless charging.

An object of the present invention is to provide a simple yet efficient electric charging circuit for a hearing instrument having a rechargeable battery.

According to the invention the above object is met by a hearing instrument, in particular a hearing instrument, as defined by claim 1. Preferred embodiments of the invention are described in the dependent claims and the subsequent description.

The hearing instrument comprises a rechargeable battery, and an electric charging circuit configured to provide an electric voltage for charging the battery. According to the invention, the electric charging circuit is equipped to support two charging modes which said two charging modes comprise a galvanic charging mode and a wireless charging mode. In the galvanic charging mode, the electric charging circuit is supplied with an electric voltage by an external voltage source via a galvanic connection to the hearing instrument. In the order to support the galvanic charging mode, preferably, the electric charging circuit comprises ports to be connected to electrical charging contacts that are accessible from the outside of the hearing instrument to which contacts a charger or a charger cable can be connected in order to establish the galvanic connection. As an alternative, such electrical charging contacts may be an intrinsic, inseparable part of the electric charging circuit. In the wireless charging mode, the electric charging circuit is supplied with an electric voltage by a wireless electric energy receiver, in particular an inductive receiver, a capacitive receiver or resonant circuit (comprising both inductive and capacitive components). The wireless electric energy receiver (being an electronic device configured to draw electric energy from a magnetic, electric or electromagnetic field in which it is immersed) may be an intrinsic and inseparable part of the electric charging circuit. In different embodiments, the wireless electric energy receiver is designed as an independent part that is manufactured separately from the electric charging circuit. In the latter case, the electric charging circuit comprises ports for electrically connecting the wireless electric energy receiver to the electric charging circuit. For both galvanic charging and wireless charging, preferably, the electric charging circuit comprises an electric charge storage device such as a capacitor in order to buffer electric energy provided to the electric charging circuit and, thus, stabilize the charging voltage provided to the battery.

The idea of equipping one and the same electric charging circuit to support both galvanic charging and wireless charging allows for realizing a compact (i.e. small in size) hearing instrument that can be charged both galvanically and wirelessly. Moreover, the electric charging circuit being equipped to support both galvanic charging and wireless charging helps increasing standardization in and, thus, simplifying the manufacture of hearing instruments as it allows for using the same electric charging circuit in different types of hearing instruments of which some may be configured for galvanic charging only whereas others may be configured for wireless charging.

However, as recognized by the inventors, it is difficult to use one and the same electric charging circuit both in galvanic and wireless charging without any modification to its structure or operational parametrization since the charging conditions, in particular with respect to the stability and reliability of the energy supply, may largely vary between galvanic and wireless charging. During galvanic charging, the electric charging circuit can rely on a stable feeding voltage provided by the charger. This is not the case for wireless charging, where the magnetic or capacitive coupling to the charger does significantly vary with the precise position of the hearing instrument with respect to the charger. Furthermore, the electric wireless energy receiver typically has a high supply impedance as compared to a galvanic connection which limits the power that can be received wirelessly. In order to compensate for these different conditions of galvanic and wireless charging, a reset voltage level (also referred to as the “Power-On-Reset (POR) threshold”) should be set significantly higher for wireless charging than for galvanic charging. Herein, the reset voltage level (POR threshold) indicates a minimum level of the charging voltage required to safely start charging the battery and operating the hearing instrument with discharged battery. The POR threshold, thus, is the level of the charging voltage at which the discharged hearing instrument starts operating after being connected to the charger. In particular, the higher POR threshold for wireless charging is desirable in order to ensure that the charging process, including data transfer between the hearing aid and the charger for authentication, testing suitability of the charger and/or adjusting the transferred power, can be started properly, even under unstable conditions.

In view of the above, in a preferred embodiment, the electric charging circuit is configured to recognize (detect) the charging mode automatically. In other words, the electric charging circuit is configured to detect automatically whether the galvanic charging mode or the wireless charging mode is used for feeding energy to the electric charging circuit. In dependence of the recognized charging mode, the electric charging circuit adjusts at least one operational parameter, in particular the POR threshold. More precisely, the electric charging circuit may be configured to set the POR threshold to a first value if the charging mode is recognized as the galvanic charging mode, and to set the POR threshold to a second value if the charging mode is recognized as the wireless charging mode, wherein said first value is lower than said second value; e.g. the first value may be set to 3V, and second value may be set to 7V.

In a preferred embodiment, the electric charging circuit comprises a full-wave bridge rectifier having two direct current (DC) terminals and two alternating current (AC) terminals, wherein the wireless electric energy receiver is connected or to be connected between said AC terminals. In this embodiment, the electric charging circuit also comprises a charging mode recognition circuit configured to automatically recognize the charging mode by virtue of a test voltage between one of said AC terminals and a ground potential at one of said DC terminals. Preferably, said charging mode recognition circuit is configured to recognize the charging mode by virtue of a DC offset of said test voltage, corresponding to the mean value of the test voltage, i.e. the temporal average over one cycle of the test voltage.

In a further preferred embodiment, said charging mode recognition circuit is configured to recognize the charging mode as being the wireless charging mode if said DC offset is above a predetermined voltage threshold (e.g. between 20% and 40%, in particular ca. 30% of the charging voltage) and/or to recognize the charging mode as being the galvanic charging mode if said DC offset is below the predetermined voltage threshold.

In a simple yet effective implementation, said charging mode recognition circuit comprises a low pass filter connected between one of the AC terminals and the ground potential to determine the DC offset of said test voltage, and a comparator to compare said DC offset with the predetermined voltage threshold.

By preference, at least one of the AC terminals of the full-wave bridge rectifier is connected to said ground potential via a high resistive connection to discharge the wireless electric energy receiver in absence of energy received by the wireless electric energy receiver, i.e. within time intervals in which no energy to fed to the wireless electric energy receiver. Herein “high resistance” means one of more resistors the total resistance is high enough not to significantly disturb wireless charging (e.g. 1 MΩ).

In accordance with embodiments of the invention, the wireless electric energy receiver may include a magnetic coil for receiving energy via magnetic induction. Preferably, the wireless electric energy receiver is formed as a resonant circuit including a capacitor connected in parallel to the magnetic coil; as an alternative, the electric charging circuit may include an electrode to receive energy via a capacitive coupling.

A further embodiment of the invention is method according to claim 11 for charging the hearing instrument according to the invention and described above. Said method for charging a hearing instrument comprises automatically recognizing the charging mode, and adjusting at least one operational parameter of the electric charging circuit, in particular the POR threshold as defined above, in dependence of the recognized charging mode.

Preferred embodiments of the method correspond to preferred embodiments of the hearing instrument as described above. Thus, teachings with respect to details, functions and benefits of embodiments of the hearing instrument do also apply to the corresponding embodiments of the method, and vice versa. In particular, in embodiments of the method,
the POR threshold may be set to a first value if the charging mode is recognized as the galvanic charging mode, and wherein the POR threshold is set to a second value if the charging mode is recognized as the wireless charging mode, wherein said first value is lower as said second value; and/or
the charging mode may be recognized automatically by virtue of said test voltage mentioned above, in particular by virtue of a DC offset of said test voltage; in particular, the charging mode may be recognized by comparing said DC offset with a predetermined voltage threshold, wherein the charging mode may be recognized as being the wireless charging mode if said DC offset is above said predetermined voltage threshold and/or the charging mode may be recognized as being the galvanic charging mode if said DC offset is below said predetermined voltage threshold.

It is preferred that the electric charging circuit is realized as an application specific integrated circuit (ASIC). However, in an alternative solution, the electric charging circuit may comprise a programmable unit such as a microcontroller or share such programmable unit with other functional parts of the hearing instrument. In this case, at least a part the functions required to operate the electric charging circuit are implemented as software that is installed and executable in the programmable unit. For example, in accordance with the invention, functional instructions for automatically recognizing the charging mode and adjusting the at least one operational parameter of the electric charging circuit mentioned above, in particular the POR threshold, independence of the recognized charging mode may be implemented as software.

In further preferred embodiments, the electric charging circuit may be configured to automatically initiate the recognition of the charging mode in response to energy being supplied by the galvanic connection or the wireless energy receiver. In particular, the charging mode recognition circuit mentioned above may be powered automatically by electric energy fed to the electric charging circuit galvanically or wirelessly.

The hearing instrument according to invention may be a part of a hearing system including a further electronic device and/or an app in addition to the hearing instrument; in particular, the further electronic device may be a charger configured to be connected to the hearing instrument for galvanically or wirelessly charging the hearing instrument.

Subsequently, embodiments of the present invention will be described with reference to the accompanying drawings in which

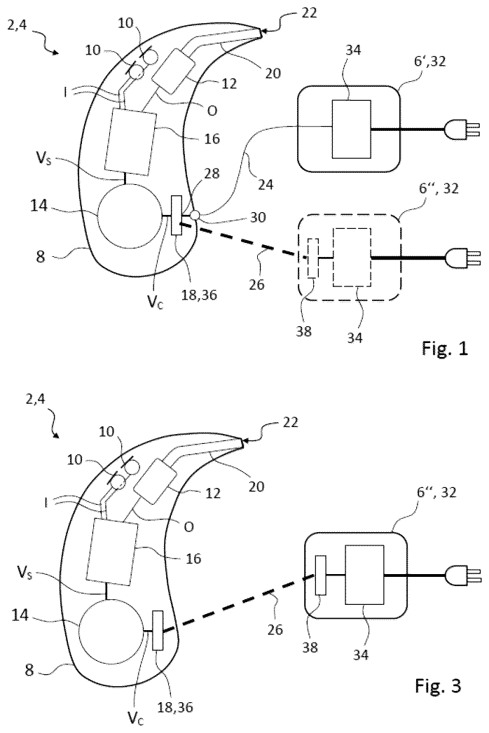

FIG. 1 shows a schematic representation of a hearing system comprising a hearing aid having a rechargeable battery and an electric charging circuit configured to provide an electric voltage for charging the battery, and a charger which may, in different embodiments, being designed to be connected to the hearing aid either via a galvanic connection or a via wireless coupling;

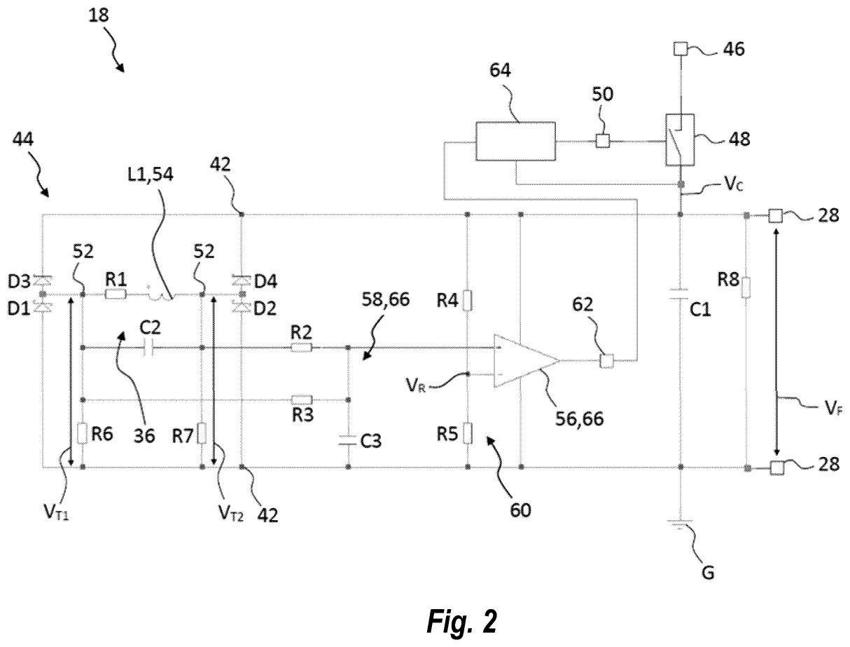

FIG. 2 shows a schematic representation of a circuit diagram of the electric charging circuit; and

FIG. 3 shows a schematic representation of another embodiment of the hearing system in which the hearing aid is designed to be charged via a wireless connection only.

Like reference numerals indicate like parts, structures and elements unless otherwise indicated.

FIG. 1 shows a hearing system 2 comprising a hearing aid 4, i.e. a hearing instrument being configured to support the hearing of a hearing-impaired user, and a charger which be either a wired charger 6′ or a wireless charger 6″.

The hearing aid 4 is configured to be worn in or at one of the ears of the user. As shown in FIG. 1, by way of example, the hearing aid 4 may be designed as a Behind-The-Ear (BTE) hearing aid. Optionally, the hearing system 2 comprises a second hearing aid (not shown) to be worn in or at the other ear of the user to provide binaural support to the user.

The hearing aid 4 comprises, inside a housing 8, two microphones 10 as input transducers and a receiver 12 as an output transducer. The hearing aid 4 further comprises a rechargeable battery 14 and a signal processor 16. Preferably, the signal processor 16 comprises both a programmable sub-unit (such as a microprocessor) and a non-programmable sub-unit (such as an ASIC). In further embodiments, the signal processor 16 may consist of a programmable unit such as a microcontroller, or be entirely non-programmable. The signal processor 16 is powered by the battery 14, i.e., the battery 14 provides an electric supply voltage V_{S} to the signal processor 16.

The hearing aid 4 also comprises an electric charging circuit 18 for charging the battery 14, i.e. for providing a charging voltage V_{C} to the battery 14.

During normal operation of the hearing aid 4, the microphones 10 record (capture) an air-borne sound from an environment of the hearing aid 4. The microphones 10 convert the air-borne sound to an input audio signal I (also referred to as the “captured sound signal”), i.e., an electric signal containing information on the captured sound. The input audio signal I is fed to the signal processor 16. The signal processor 16 processes the input audio signal I, e.g., to provide a directed sound information (beam-forming), to perform noise reduction and dynamic compression, and to individually amplify different spectral portions of the input audio signal I based on audiogram data of the user in order to compensate for the user-specific hearing loss. The signal processor 16 emits an output audio signal O (also referred to as the “processed sound signal”), i.e., an electric signal containing information on the processed sound, to the receiver 12. The receiver 12 converts the output audio signal O into processed air-borne sound that is emitted into the ear canal of the user, via a sound channel 20 connecting the receiver 12 to a tip 22 of the housing 8 and a flexible sound tube (not shown) connecting the tip 22 to an ear piece (not shown) inserted in the ear canal of the user.

In a different embodiment (not shown), the hearing aid 4 may be designed as a RIC device. In this case, different from FIG. 1, the receiver 12 of the hearing aid 4 is located in the ear piece and, thus, outside the housing 8. Instead of the sound channel 20 and the sound tube, the RIC hearing aid 4 comprises an electric wire that connects the ear piece to the housing 8 and is used for feeding the output audio signal O from the signal processor 16 to the external receiver 12.

In the embodiment of FIG. 1, as mentioned above, the hearing aid 4 can be charged both galvanically, i.e. via an electrically conductive connection 24 between the charger 6′ and the hearing aid 4, and wirelessly, i.e. via a wireless coupling 26 between the charger 6″ and the hearing aid 4. This means that, at the choice of the user, either one of the chargers 6′ and 6″ can be connected to the same hearing aid 4 (however not both chargers 6′ and 6″ at the same time).

To this end, the electrical charging circuit 18 of the hearing 4 is configured to support both a galvanic charging mode and a wireless charging mode.

In order to support galvanic charging, the electric charging circuit 18 comprises ports 28 (i.e. electrical connections such as pins or legs of an integrated circuit) that, in the embodiment of FIG. 1, are connected to electrical charging contacts 30 being accessible from the outside of the housing 8. For example, the contacts 30 be realized as parts of an electrical socket (i.e. a female connector) that corresponds to a matching plug (i.e. a male connector) of the electrically conductive connection 24. As an alternative, the contacts 30 may be realized as contact pads inserted in and aligned with an outer skin of the housing 8 that are designed to make contact with the charger 6′ by abutting against corresponding contact pads or contact springs of the charger 6′.

The electrically conductive connection 24 of the charger 6′ may be realized as a charging cable as implied by FIG. 1. As an alternative, the charger 6 may have a housing 32 designed to directly abut against or receive the hearing aid 4. In this case, a terminal end of the connection 24 (e.g. a plug, contact pads or spring contacts forming the counter parts to the charging contacts 30 of the hearing aid 4) are inserted directly in the housing 32 of the charger 6″. In order to supply electric energy, the charger 6′ comprises a power supply 34 that may be realized, as shown in FIG. 1, as an AC power supply to be connected to an electric network. Alternatively, the power supply 34 may be realized as a DC power supply such as an USB port. In addition or as an alternative to the (AC or DC) power supply 34, the charger 6′ may comprise a battery (not shown). During galvanic charging, the charger 6′ supplies a DC voltage (subsequently referred to as the “feeding voltage V_{F}”; e.g. of 9 V DC) to the electric charging circuit 18 via the connection 24.

In order to support wireless charging, the electric charging circuit 18 comprises an integrated wireless electric energy receiver 36 being formed, e.g., as a resonant circuit. Different from the wired charger 6′, the wireless charger 6″ comprises a wireless electric energy transmitter 38 in addition to the (AC or DC) power supply 34 and/or the battery. In the embodiment of FIG. 1, the electric energy transmitter 38 comprises a magnetic coil and an oscillator or inverter, said oscillator or inverter being configured to convert a DC voltage supplied by the power supply 34 or battery to a high frequency voltage (e.g. at a frequency of 13.56 MHz) fed to the magnetic coil. The wireless coupling 26 is formed by an alternating magnetic field emitted by the magnetic coil of the transmitter 38 (when supplied with said high frequency voltage) and received by the receiver 36 of the electric charging circuit 18.

When receiving electric energy via electrically conductive connection 24 or the wireless coupling 26, the electric charging circuit 18 supplies the charging voltage V_{C} to the battery 14.

FIG. 2 shows the structure of the electric charging circuit 18 in greater detail. As can be seen from this figure, both the ports 28 and two (DC) terminals 42 of a full-wave bridge rectifier 44, are connected in parallel to the both sides of a capacitance C1. A minus side of the capacitance C1 (to which one of the ports 28 and one of the DC terminals 42 are connected) is connected to ground G (i.e. a mass potential). A plus side of the capacitance C1 (to which the other one of the ports 28 and the other one of the DC terminals 42 are connected) is connected to a (charging voltage) port 46, via a switch 48. The switch 48 which, preferably, is realized as a semiconductor switch (e.g. and IGBT or MOS-FET), can be actuated electronically via a (control) port 50. In alternative embodiments, the electric charging circuit 18 includes a voltage or current regulator instead of the switch 48. The voltage or current regulator is controlled via the control port 50 to regulate the voltage or current fed to the battery 14 during charging.

The full-wave bridge rectifier 44 is formed by two lower Schottky diodes D1, D2 and two upper Schottky diodes D3, D4. Herein, the diodes D1 and D3 and the diodes D2 and D4 are connected in series, respectively; the terms “lower” and “upper” refer to the position of the respective diode with respect to the respective potential gradient over the diodes D1 or D3 and the diodes D2 and D4.

The wireless electric energy receiver 36 is connected between two (AC) terminals 52 of the full-wave bridge rectifier 44 which AC terminals 52 are located between the diodes D1 and D3 and the diodes D2 and D4, respectively.

The wireless electric energy receiver 36 comprises a capacitance C2 connected in parallel to a series of an inductance L1 and a resistance R1. Herein, the inductance L1 is formed by a (magnetic) coil 54.

Both (AC) terminals 52 and, thus, both sides of the wireless electric energy receiver 36 are connected to the plus side of a comparator 56, via a low pass filter 58. The low pass filter 58 is formed by two resistances R2 and R3 and a capacitance C3. Herein, each one of the resistances R2 and R3 connects one of the (AC) terminals 54 to the plus side of the capacitance C3. The minus side of the capacitance C3 is connected to ground G.

The comparator 56 is powered by (i.e. receives its operating voltage and ground potential from) the capacitance C1. Moreover, a voltage divider 60 formed by resistances R4 and R5 is connected between the two sides of the capacitance C1. A reference voltage V_{R} between the resistances R4 and R5 is applied to the minus side (reference input) of the comparator 56. The output of the comparator 56 is connected to a charging mode flag port 62 of the electric charging circuit 18.

The charging mode flag port 62 is connected to a charging controller 64 of the electric charging circuit 18. An output of the charging controller 64 is connected to the control port 50 of the switch 48 (or the voltage or current regulator that may be included instead of the switch 48). Furthermore, the charging voltage V_{C} (i.e. the voltage of the capacitance C1) is fed to the charging controller 64, both for operating the charging controller 64 (independently of the charging state of the battery 14) and for monitoring the charging voltage V_{C} by the charging controller 64.

High resistances R6 and R7 connect the the two AC terminals 52 of the full-wave bridge rectifier 44 and, thus, both sides of the wireless electric energy receiver 36, to ground G. A further high resistance R8 is connected in parallel to the capacitance C1.

During galvanic charging, the charger 6′ directly applies the feeding voltage V_{F} to the capacitance C1, via the electrically conductive connection 24 (e.g. the charging cable), contacts 30 and ports 28, and the capacitance C1 is charged, enabling the capacitance C1 to provide the charging voltage V_{C}.

During wireless charging, an alternating voltage is induced in the wireless electric energy receiver 36 (i.e. the resonant circuit formed by the inductance L1, the capacitance C2 and the resistance R1). Said alternating voltage is rectified by the full-wave bridge rectifier 44 (formed by the diodes D1, D2, D3 and D4). The rectified voltage output by the full-wave bridge rectifier 44 at its DC terminals 42, again, charges the capacitance C1 enabling the latter to provide the charging voltage V_{C}.

The charging controller 64 compares the current value of the charging voltage V_{C} to a pre-set reset voltage level, denoted as POR threshold. For the reasons explained above, the POR threshold is set differently for the galvanic mode and the wireless charging mode. In fact, in the shown embodiment, the POR threshold is set to 3 V for the galvanic charging mode and to 7 V for the wireless charging mode.

Within the electric charging circuit 18, the low pass filter 58 and the comparator 56 are used to automatically recognize the charging mode as being one of the galvanic charging mode or the wireless charging mode when electric energy is supplied to the capacitance C1, either galvanically or wirelessly. The low pass filter 58 and the comparator 46, thus, form a charging mode recognition circuit 66. The charging mode recognition circuit 66 recognizes the charging mode by monitoring a respective voltage between each one of the AC terminals 52 of the full-wave bridge rectifier 44 and ground G. As these voltages are used for testing for the charging mode, they are referred to as test voltages V_{T1} and V_{T2}. The charging mode recognition circuit 66 uses the fact that a DC offset of the test voltages V_{T1} and V_{T2} is significantly different for galvanic charging and wireless charging. The DC offset of the test voltages V_{T1} and V_{T2} corresponds to the mean value of the respective test voltage V_{T1} or V_{T2}, i.e. the temporal average over one cycle of the respective test voltage V_{T1} or V_{T2}.

During galvanic charging, the entire charging voltage V_{C} of the capacitor C1 drops over the upper diodes D3 and D4 of the full-wave bridge rectifier 44, whereas no voltage is output by the wireless electric energy receiver 36. Thus, both test voltages V_{T1} and V_{T2} and their respective DC offset have a zero value or are at least close to zero, as is ensured by the resistances R6 and R7.

During wireless charging, the alternating voltage induced in the wireless electric energy receiver 36 results in an oscillation of both test voltage V_{T1} or V_{T2} between a value close to zero and a positive value (since the lower diodes D1 and D2 start to conduct when the potential at the corresponding AC terminal 52 becomes negative). Thus, the DC offset of the test voltages V_{T1} and V_{T2} assumes a positive value. If the alternating voltage induced in the wireless electric energy receiver 36 has an amplitude of, e.g., 10 V, then the DC offset of the test voltages V_{T1} and V_{T2} has a DC offset of ca. 5 V.

In order to automatically recognize the charging method, the low pass filter 58 extracts the DC offset of the test voltages V_{T1} and V_{T2} and feeds said DC offset to the plus side of the comparator 56. The comparator 56 compares the DC offset with a reference voltage V_{R} (previously termed the “voltage threshold”) delivered by the voltage divider 60 and recognizes the charging mode as being the wireless charging mode if said DC offset is above said reference voltage V_{R}. Preferably, by design of the voltage divider, the reference voltage V_{R} is set such that is well between 0V and half of the charging voltage V_{C} (e.g. ≤2.25 V or ≤3 V if the charging voltage is 9 V). In this case, i.e. if the comparator 56 recognizes the charging mode as being the wireless charging mode, the comparator 56 switches its output and the signal at the charging mode flag port 62 to a logical HIGH state, thus indicating recognition of the wireless charging mode. Otherwise, the comparator 56 keeps its output and the signal at the charging mode flag port 62 at a logical LOW state, thus indicating that the charging voltage V_{C} (if different from zero) was caused by galvanic charging. Since the comparator 56 is powered by the charging voltage V_{C}, the electric charging circuit 18 automatically initiates the recognition of the charging mode in response to energy being supplied to the capacitance C1 either galvanically or wirelessly.

In dependence of the signal state at the charging mode flag port 62 and, thus, in dependence of the recognized charging mode, the charging controller 64 adjusts the POR threshold as described above.

Via its output and the control port 50, the charging controller 64 closes the switch 48 when the charging voltage V_{C} exceeds the POR threshold, resulting in the charging voltage V_{C} being delivered to the charging voltage port 46. As a consequence, the charging the battery 14 is started. If the hearing aid 4 had been switched off before, it is switched on and started by closing the switch 48. The switch 48 is kept in the closed state as long as the charging voltage V_{C} exceeds the POR threshold. In embodiments in which the switch 48 is replaced by a voltage or current regulator, the charging controller 64 controls said voltage or current regulator, via its output and the control port 50, such that a regulated non-zero voltage or a regulated non-zero current is applied to the battery 14, via the charging voltage port 46, as soon and as long as the charging voltage V_{C} exceeds the POR threshold.

Furthermore, the charging controller 64 initiates data transfer with the charger 6′, 6′, in dependence of the recognized charging mode. For example, the hearing aid 4 may use different modulation techniques for data transfer to the wired charger 6′ via the electrically conductive connection 24 and for data transfer to the wireless charger 6″ via the wireless coupling 26.

Outside charging intervals, i.e. when no electric energy is fed the electric charging circuit 18, the capacitance C1 is discharged via the resistance R8. The resistance R8 is chosen high enough not to significantly disturb the charging process.

By preference, the electric charging circuit 18 as shown in FIG. 2 is realized as an ASIC. In a modified embodiment, at least one of the switch 48, the magnetic coil 54 (or the wireless electric energy receiver 36 as a whole) and/or the charging controller 64 may not be parts of said ASIC but manufactured independently thereof.

In embodiments in which the wireless electric energy receiver 36 is an intrinsic part of an ASIC implementing the electric charging circuit 18, preferably, the circuit 18 is designed such that the wireless electric energy receiver 36 can be activated and deactivated without modifying the ASIC. For example, at least one of the AC terminals 52 and the corresponding side of the wireless electric energy receiver 36 (or, at least, the magnetic coil 54) may be unconnected in the unmounted state of the ASIC. Instead, this AC terminal 52 and the corresponding side of the wireless electric energy receiver 36 (or the magnetic coil 54) may be connected to ports (e.g. pins or legs) of the ASIC accessible from the outside of the ASIC such that the wireless electric energy receiver 36 can be activated by connecting the corresponding ports during mounting the ASIC on a circuit board, or can be deactivated by leaving said ports idle (i.e. unconnected).

In a suited layout, the parts of the electric charging circuit 18 may be dimensioned as follows:

$$C 1 = 200 nF$$

$$C 2 = 1 , 26 nF$$

$$L 1 = 110 n H$$

$$R 1 = 200 m Ω$$

$$R 2 = 1 MΩ$$

$$R 3 = 1 MΩ$$

$$C 3 = 100 pF$$

$$R 4 = 2 MΩ$$

$$R 5 = 1 MΩ$$

$$R 6 = 1 MΩ$$

$$R 7 = 1 MΩ$$

$$R 8 = 10 k Ω$$

Although being configured to support both galvanic charging and wireless charging, the electric charging circuit 18 can be applied in hearing aids or other instruments that allow only one of these two charging modes. The application of the electric charging circuit 18 in hearing instruments of those kinds is beneficial with respect to efficient manufacture of different product lines of hearing instruments differing in accessible charging modes as the electric charging circuit 18 can be used in several or all of those product lines and, thus, the number of parts can be reduced.

As an example, FIG. 3 shows a hearing system 2 similar to the one of FIG. 1. However, in the embodiment of FIG. 3, the hearing aid 4 can be charged in the wireless charging mode only. Differing from the embodiment of FIG. 1, the hearing aid 4 of FIG. 3 is not provided with charging contacts 30. The electric charging circuit 18 of this hearing aid 4, nevertheless, corresponds to the embodiment of FIG. 2. However, in the case of FIG. 3, the ports 28 for galvanic charging are left idle (i.e. uncontacted).

In another example (not shown), the hearing aid 4 may be designed such that it can be charged in the galvanic charging mode only. This hearing aid 4 may still correspond to the one shown in FIGS. 1 and 2. However, in this case, the wireless electric energy receiver 36 (or, at least, the magnetic coil 54) may be deactivated or, if possible, not provided to the hearing aid 4.

It will be appreciated by persons skilled in the art that numerous variations and/or modifications may be made to the invention as shown in the specific examples without departing from the spirit and scope of the invention as broadly described in the claims. The present examples are, therefore, to be considered in all aspects as illustrative and not restrictive. In particular, different from the examples shown in FIGS. 1 and 2, the hearing aid 4 may be realized as an ITE instrument or as an implanted instrument. Moreover, instead of the electro-acoustical receiver 12, the hearing aid 4 may comprise an electro-mechanical transducer or an output transducer directly stimulating the auditory nerve of the user.

### LIST OF REFERENCE NUMERALS

2 hearing system
4 hearing aid
6′ (wired) charger
6″ (wireless) charger
8 housing (of hearing aid 4)
10 microphone
12 receiver
14 battery
16 signal processor
18 electric charging circuit
20 sound channel
22 tip
24 (electrically conductive) connection
26 (wireless) coupling
28 port
30 (charging) contact
32 housing (of charger 6′ or 6″)
34 power supply
36 (wireless electric energy) receiver
38 (wireless electric energy) transmitter
42 (DC) terminal
44 full-wave bridge rectifier
46 (charging voltage) port
48 switch
50 (control) port
52 (AC) terminal
54 (magnetic) coil
56 comparator
58 low pass filter
60 voltage divider
62 charging mode flag port
64 charging controller
66 charging mode recognition circuit
C1 capacitance
C2 capacitance
C3 capacitance
D1 (Schottky) diode
D2 (Schottky) diode
D3 (Schottky) diode
D4 (Schottky) diode
G ground
I input audio signal
L1 inductance
O output audio signal
R1 resistance
R2 resistance
R3 resistance
R4 resistance
R5 resistance
R6 resistance
R7 resistance
R8 resistance
V_{C} charging voltage
V_{F} feeding voltage
V_{R} reference voltage
V_{S} supply voltage
V_{T1} test voltage
V_{T2} test voltage

1. A hearing instrument comprising a rechargeable battery, and an electric charging circuit configured to provide an electric charging voltage for charging the battery, wherein the electric charging circuit is equipped to support two charging modes, comprising
a galvanic charging mode in which the electric charging circuit is supplied with an electric voltage by an external voltage source via a galvanic connection to the hearing instrument, and
a wireless charging mode in which the electric charging circuit is supplied with an electric voltage by a wireless electric energy receiver.

2. The hearing instrument according to claim 1, wherein the electric charging circuit is configured to automatically recognize the charging mode, and to adjust at least one operational parameter in dependence of the recognized charging mode.

3. The hearing instrument according to claim 2, wherein the at least one operational parameter being adjusted in dependence of the recognized charging mode comprises a reset voltage level indicating a level of the charging voltage sufficient for safely charging the battery and operating the hearing instrument.

4. The hearing instrument according to claim 3, wherein the electric charging circuit is configured to set the reset voltage level to a first value if the charging mode is recognized as the galvanic charging mode, to set the reset voltage level to a second value if the charging mode is recognized as the wireless charging mode, wherein said first value is lower than said second value.

5. The hearing instrument according to claim 2, wherein the electric charging circuit comprises
a full-wave bridge rectifier having two DC terminals and two AC terminals, wherein the wireless electric energy receiver is connected between said AC terminals, and
a charging mode recognition circuit configured to automatically recognize the charging mode by virtue of a test voltage between one of said AC terminals and a ground potential at one of said DC terminals.

6. The hearing instrument according to claim 5, wherein said charging mode recognition circuit is configured to recognize the charging mode by virtue of a DC offset of said test voltage.

7. The hearing instrument according to claim 6, wherein said charging mode recognition circuit is configured to recognize the charging mode as being the wireless charging mode if said DC offset is above a predetermined voltage threshold and/or to recognize the charging mode as being the galvanic charging mode if said DC offset is below the predetermined voltage threshold.

8. The hearing instrument according to claim 7, wherein said charging mode recognition circuit comprises a low pass filter connected between one of the AC terminals and the ground potential to determine the DC offset of said test voltage, and a comparator to compare said DC offset with the predetermined voltage threshold.

9. The hearing instrument according to claim 5, wherein at least one of said AC terminals is connected to said ground potential via a high resistance to discharge the wireless electric energy receiver in absence of energy received by the wireless electric energy receiver.

10. The hearing instrument according to claim 1, wherein at least a part of the electric charging circuit is realized as an application specific integrated circuit.

11. A method for charging a hearing instrument comprising a rechargeable battery, and an electric charging circuit configured to provide an electric charging voltage for charging the battery and equipped to support two charging modes, comprising
a galvanic charging mode in which the electric charging circuit is supplied with an electric voltage by an external voltage source via a galvanic connection, and
a wireless charging mode in which the electric charging circuit is supplied with an electric voltage by a wireless electric energy receiver,
the method comprising:
automatically recognizing the charging mode, and
adjusting at least one operational parameter of the electric charging circuit in dependence of the recognized charging mode.

12. The method according to claim 11, wherein the at least one operational parameter being adjusted in dependence of the recognized charging mode comprises a reset voltage level indicating a level of the charging voltage sufficient for safely charging the battery and operating the hearing instrument.

13. The method according to claim 12, wherein the reset voltage level is set to a first value if the charging mode is recognized as the galvanic charging mode, and wherein the set voltage level is set to a second value if the charging mode is recognized as the wireless charging mode, wherein said first value is lower as said second value.

14. The method according to claim 11, wherein the electric charging circuit comprises a full-wave bridge rectifier having two DC terminals and two AC terminals, wherein the wireless electric energy receiver is connected between said AC terminals, the method comprising:
detecting a test voltage between one of said AC terminals and a ground potential at one of said DC terminals, and
automatically recognizing the charging mode by virtue of said test voltage, in particular by virtue of a DC offset of said test voltage.

15. The method according to claim 14, comprising:
comparing said DC offset with a predetermined voltage threshold, and
recognizing the charging mode as being the wireless charging mode if said DC offset is above said predetermined voltage threshold and/or recognizing the charging mode as being the galvanic charging mode if said DC offset is below said predetermined voltage threshold.
